(19) United States
(12) Patent Application Publication
(10) Pub. No.: US 2007/0138839 A1
(43) Pub. Date: Jun. 21, 2007

(54) Support beam for vehicle

(75) Inventors: Yong Soo Lee, Jeonrabuk-Do (KR); Tae Young Son, Jeonrabuk-Do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/305,407

(22) Filed: Dec. 15, 2005

(30) Foreign Application Priority Data
Dec. 12, 2005 (KR) 10-2005-012209

(51) Int. Cl. B60J 7/00

(52) U.S. Cl. 296/204

(57) ABSTRACT

A support beam for a vehicle of the present invention includes a first supporting member, a second supporting member, and a mounting member. One end portion of the first supporting member is arched like a bow, and one end portion of the second supporting member is arched like a bow. The One end of the first supporting member is disposed on one end of the mounting member, the other end of the second supporting member is disposed on the other end of the mounting member, and a rear axle is mounted on the mounting member.

### CROSS-REFERENCE TO RELATED APPLICATION

This application claims priority to and the benefit of Korean Patent Application No. 10-2005-0122059 filed in the Korean Intellectual Property Office on Dec. 12, 2005, the entire contents of which are incorporated herein by reference.

### BACKGROUND OF THE INVENTION

(a) Field of the Invention

The present invention relates to a vehicle, and in particular, to a support beam for a vehicle.

(b) Description of the Related Art

In general, a support beam for a vehicle supports sprung weight of the vehicle and a rear axle, and both ends thereof are arched like a bow.

In particular, the support beam for a vehicle includes an upper panel with a channel shape and a lower panel with a channel shape, and the upper panel and the lower panel are welded to each other.

In addition, four bolt holes are formed at each center portion of the upper and lower panels so as to mount the rear axle thereto. Furthermore, the rear axle is disposed on the center portion of the upper panel, two U-shaped bolts are inserted into the bolt holes, and consequently the rear axle is mounted to the support beam by coupling four nuts thereto. Here, the rear axle includes a housing and a shaft rotatably disposed in the housing.

In addition, in order to reinforce the upper and lower panels at the coupling, an upper plate which is formed of a reinforced metal is welded to a top part of the center portion of the upper panel, and a lower plate which is formed of a reinforced metal is welded to a lower part of the center portion of the lower panel.

However, such a conventional support beam for a vehicle may have the following problems.

In a case that the nuts are respectively coupled to both ends of the U-shaped bolts after the bolts are inserted into the bolt holes, buckling may be produced to the upper and lower panels by a coupling force thereof.

In addition, since gaps between bolt holes of the upper and lower plates and the bolts become larger by such buckling, rigidity of the bolts may be reduced.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a support beam for a vehicle having advantages of preventing buckling from occurring.

A support beam for a vehicle according to an embodiment of the present invention includes a first supporting member, one end portion of which is arched like a bow; a second supporting member, one end portion of which is arched like a bow; and a mounting member to which the other end of the first supporting member is disposed on one end thereof, to which the other end of the second supporting member is disposed on the other end thereof, and on which a rear axle is mounted.

In a further embodiment, the mounting member includes a body formed of a rigid material; a plurality of coupling holes which are formed at the body so as to mount the rear axle to the body using mounting bolts; a first projection which is formed at the body, and which is inserted into an interior surface of the other end of the first supporting member; and a second projection which is formed at the body, and which is inserted into an interior surface of the other end of the second supporting member.

In a further embodiment, a plurality of penetration holes are further formed at the body in a downward direction of the rear axle.

In a further embodiment, the body has a rectangular parallelepiped shape, and the first and second projections have a rectangular shape and are hollow.

In a further embodiment, the mounting member further includes a coupling portion which is integrally formed to a side surface of the body so as to couple a suspension thereto.

In a further embodiment, the support beam for a vehicle according to an embodiment of the present invention includes a first disposing part which is mounted on the other end portion of the first supporting member so as to dispose a first absorbing member thereto; and a second disposing part which is mounted on the other end portion of the second supporting member so as to dispose a second absorbing member thereto.

### BRIEF DESCRIPTION OF THE DRAWINGS

FIG. 1 is a perspective view showing a support beam for a vehicle according to an embodiment of the present invention.

FIG. 2 is a downward perspective view of a mounting member in a support beam for a vehicle according to an embodiment of the present invention.

FIG. 3 is an upward perspective view of the mounting member in a support beam for a vehicle according to an embodiment of the present invention.

FIG. 4 shows a state in which a support beam for a vehicle according to an embodiment of the present invention is mounted to a principal part of a vehicle.

### DESCRIPTION OF REFERENCE NUMERALS INDICATING PRIMARY ELEMENTS IN THE DRAWINGS

| | | | |
|---|---|---|---|
| 10: | rear axle | 100: | first supporting member |
| 110: | first disposing part | 300: | second supporting member |
| 310: | second disposing part | 500: | mounting member |
| 510: | body | 530: | coupling holes |
| 540: | first projection | 550: | second projection |
| 560: | penetration holes | 570: | coupling portion |

### DETAILED DESCRIPTION OF THE EMBODIMENTS

With reference to the accompanying drawings, the present invention will be described in order for those skilled in the art to be able to implement the invention. As those skilled in the art would realize, the described embodiments may be modified in various different ways, all without departing from the spirit or scope of the present invention.

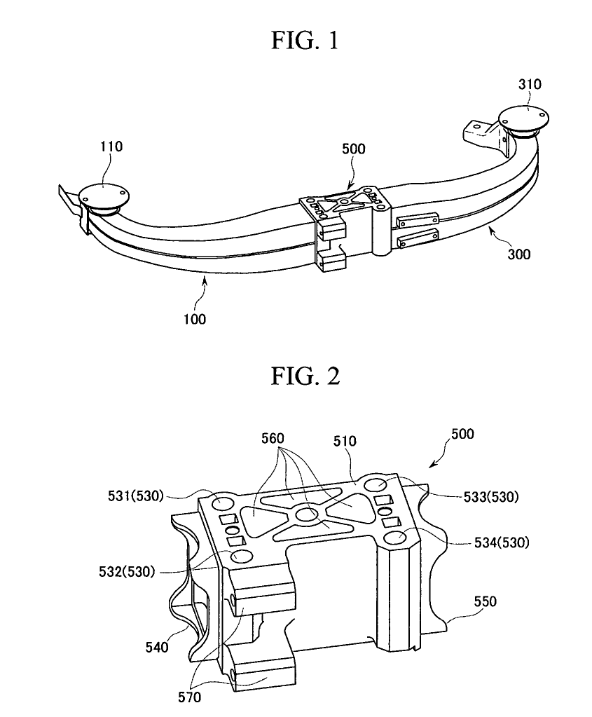

FIG. 1 is a perspective view showing a support beam for a vehicle according to an embodiment of the present invention.

A support beam for a vehicle according to an embodiment of the present invention is for supporting sprung weight of vehicle and a rear axle, as shown in FIG. 1, and it includes a first supporting member 100, a second supporting member 300, and a mounting member 500.

The first and second supporting members 100 and 300 respectively include one end portion that is arched like a bow. Furthermore, each of the first and second supporting members 100 and 300 includes an upper panel (not shown) and a lower panel (not shown), and the upper and lower panels are welded to each other.

The other end of the first supporting member 300 is disposed on one end of the mounting member 500, the other end of the second supporting member 300 is disposed on the other end of the mounting member 500, and a rear axle (refer to “10” in FIG. 4) is coupled to the mounting member 500.

Since the rear axle 10 is coupled to the mounting member 500 that is separately provided, the first supporting member 100 and the second supporting member 300 do not receive an influence of a coupling force generated at the coupling. As a result, since buckling is not produced, rigidity of mounting bolts (refer to “13” in FIG. 4) can be maintained.

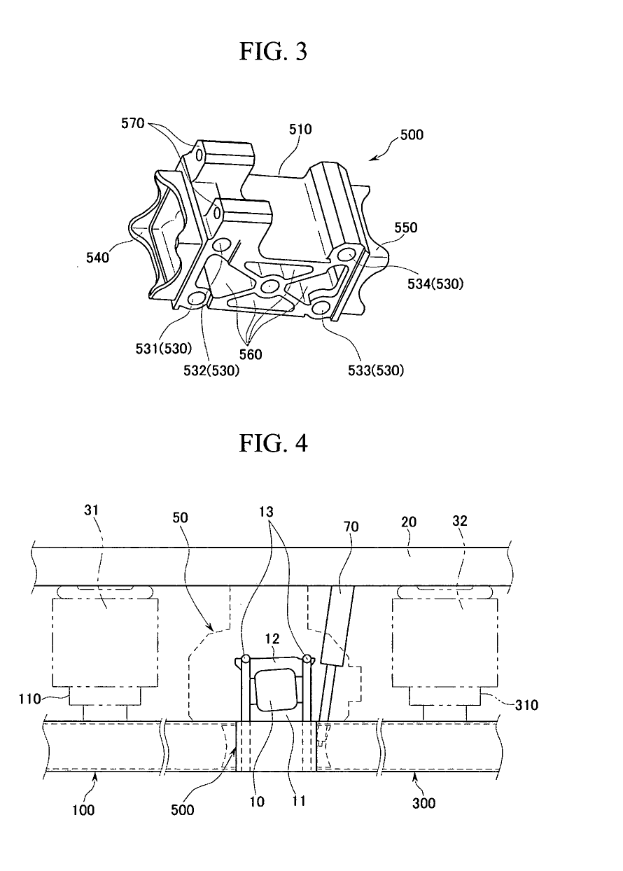

FIG. 2 is a downward perspective view of a mounting member, in a support beam for a vehicle according to an embodiment of the present invention. FIG. 3 is an upward perspective view of the mounting member, in a support beam for a vehicle according to an embodiment of the present invention.

With reference to FIGS. 2 and 3, the mounting member 500 will be hereinafter described in detail.

The mounting member 500 may include a body 510, a plurality of coupling holes 530, a first projection 540, and a second projection 550.

The body 510 is formed of a rigid material, and it has a solid shape. In addition, in order to reduce weight of the mounting member 500 and to reinforce it, a plurality of penetration holes 560 may be formed at the body in a downward direction of the rear axle 10.

The plurality of coupling holes 530 are formed at the body 510 so as to mount the rear axle 10 to the body 510 using mounting bolts 13. In more detail, the plurality of coupling holes 530 may include first, second, third, and fourth coupling holes 531, 532, 533 and 534, and each of the mounting bolts 13 may be U-shaped.

The first projection 540 is formed at the body 510, and it is inserted into an interior surface of the other end of the first supporting member 100.

The second projection 550 is formed at the body 510, and it is inserted into an interior surface of the other end of the second supporting member 300.

In addition, the body 510 may have a rectangular parallelepiped shape, and the first and second projections 540 and 550 may have a rectangular shape and be hollow so as to reduce the weight of the mounting member and reinforce rigidity of the first and second projections 540 and 550.

FIG. 4 shows a state in which a support beam for a vehicle according to an embodiment of the present invention is mounted to a principal part of a vehicle.

The above-mentioned mounting member 500, as shown in FIGS. 1 and 4, may further include a coupling portion 570 which is integrally formed to a side surface of the body 510 so as to couple a suspension 70 thereto.

In addition, the support beam for a vehicle according to an embodiment of the present invention, as shown in FIG. 4, may further include a first disposing part 110 and a second disposing part 310. The first disposing part 110 is mounted on the other end portion of the first supporting member 100 so as to dispose a first absorbing member 31 (e.g., an air spring). A second disposing part 310 is mounted on the other end portion of the second supporting member 300 so as to dispose a second absorbing member 32 (e.g., an air spring).

With reference to FIGS. 1 to 4, assembling steps of the support beam for a vehicle according to an embodiment of the present invention will be hereinafter described.

The first supporting member 100 is inserted onto the first projection 540 formed at one end of the mounting member 500, and it is welded onto the mounting member 500. The second supporting member 300 is inserted onto the second projection 550 formed at the other end of the mounting member 500, and it is welded onto the mounting member 500.

In addition, a lower seat 12 is disposed on an upper end of the mounting member 500, and the rear axle 10 is disposed on the lower seat 12. An upper seat 11 is disposed on an upper end of the rear axle 10, and the U-shaped bolts 13 are coupled thereto.

The first air spring 31 is disposed on the first disposing part 110, and the second air spring 32 is disposed on the second disposing part 310.

The suspension 70 is coupled to the coupling portion 570.

A vehicle body frame 20 is disposed on both the first air spring 31 and the second air spring 32.

As has been explained, the support beam for a vehicle according to an embodiment of the present invention may have the following advantages.

According to the embodiment of the present invention, since a rear axle is coupled to a separately provided mounting member, a first supporting member and a second supporting member do not receive an influence of a coupling force generated at the coupling. As a result, since buckling is not produced, rigidity of the mounting bolts can be maintained.

In addition, according to the embodiment of the present invention, since upper and lower plates for reinforcing upper and lower panels are not provided, weight and cost can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A support beam for a vehicle, comprising:
a first supporting member, one end portion of which is arched like a bow;
a second supporting member, one end portion of which is arched like a bow; and
a mounting member of which the other end of the first supporting member is disposed on one end thereof, of which the other end of the second supporting member is disposed on the other end thereof, and on which a rear axle is mounted.

2. The support beam of claim 1, wherein
the mounting member comprises:
a body formed of a rigid material;
a plurality of coupling holes which are formed at the body so as to mount the rear axle to the body using mounting bolts;
a first projection which is formed at the body, and which is inserted into an interior surface of the other end of the first supporting member; and
a second projection which is formed at the body, and which is inserted into an interior surface of the other end of the second supporting member.

3. The support beam of claim 2, wherein:
a plurality of penetration holes are further formed at the body in a downward direction of the rear axle.

4. The support beam of claim 2, wherein:
the body has a rectangular parallelepiped shape; and
the first and second projections have a rectangular shape and are hollow.

5. The support beam of claim 2, wherein:
the mounting member further comprises a coupling portion which is integrally formed to a side surface of the body so as to couple a suspension thereto.

6. The support beam of claim 1, further comprising:
a first disposing part which is mounted on the other end portion of the first supporting member so as to dispose a first absorbing member thereto; and
a second disposing part which is mounted on the other end portion of the second supporting member so as to dispose a second absorbing member thereto.

7. A support beam for a vehicle, comprising:
a first supporting member comprising an arched end portion;
a second supporting member comprising an arched end portion; and
a mounting member of which the other end of the first supporting member is disposed on one end thereof, of which the other end of the second supporting member is disposed on the other end thereof.

8. The support beam of claim 7 wherein a rear axle is mounted on the mounting member.

9. A vehicle comprising a support beam of claim 1.

10. A vehicle comprising a support beam of claim 7.
